(19) United States
(12) Patent Application Publication
(10) Pub. No.: US 2024/0043336 A1
(43) Pub. Date: Feb. 8, 2024

(54) ALUMINA-BASED FUSED GRAIN

(71) Applicant: SAINT-GOBAIN CENTRE DE RECHERCHES ET D'ETUDES EUROPEEN, COURBEVOIE (FR)

(72) Inventors: Nadia FREDERICH, L'ISLE-SUR-LA-SORGUE (FR); Samuel Noel Patrice MARLIN, PLAN D'ORGON (FR); Shuqiong LIANG, Shanghai (CN)

(21) Appl. No.: 18/265,672

(22) PCT Filed: Dec. 1, 2021
(86) PCT No.: PCT/EP2021/083832

§ 371 Date: Jun. 6, 2023

(30) Foreign Application Priority Data
Dec. 7, 2020 (FR) 2012788

(51) Int. Cl. C04B 35/109; C04B 35/653; B24D 3/14

(52) U.S. Cl. CPC C04B 35/109; C04B 35/653; B24D 3/14; C04B 2235/3217; C04B 2235/3225; C04B 2235/3244; C04B 2235/721; C04B 2235/725; C04B 2235/728; C04B 2235/765; C04B 2235/762

(57) ABSTRACT

Disclosed is a fused grain having the following chemical composition, expressed in percentages by mass on the basis of the oxides: ZrO₂+HfO₂: 2% to 13%; elements other than ZrO₂, HfO₂, Y₂O; and Al₂O₃: ≤2%. Y₂O₃+Al₂O₃: made up to 100%; with 0.0065≤Y₂O;/(ZrO₂+HfO₂)≤0.1300.

### TECHNICAL FIELD

The present invention relates to a fused grain, in particular for applications as abrasive grains. The invention also relates to a mixture of said grains and also to an abrasive tool comprising a mixture of grains in accordance with the invention.

### PRIOR ART

Abrasive tools are generally classified according to the method of forming the grains which are incorporated in the compositions thereof: free abrasives (use in spraying or in suspension, without a support), coated abrasives (support of cloth or paper type, where the grains are positioned over several layers) and bonded abrasives (in the form of circular grinding wheels, sticks, etc.). In the latter cases, the abrasive grains are pressed with an organic or glassy binder (in this case, a binder composed of oxides which is essentially silicated). These grains must themselves have good abrasion mechanical properties in abrasion and lead to good mechanical cohesion with the binder (durability of the interface).

Among the abrasive grains, a distinction is made between fused cast grains and sintered grains, which have different microstructures. The problems posed by sintered grains and by fused cast grains, and the technical solutions adopted to solve them, are therefore generally different. A composition developed for manufacturing a fused cast grain is therefore not a priori usable for manufacturing a sintered ceramic grain having the same properties, and vice versa.

The fused alumina-based grains generally used in the manufacture of grinding wheels or of abrasive belts combine two main categories depending on the type of application and abrasion regime encountered: fused alumina-zirconia grains and fused alumina grains.

Fused alumina-zirconia grains are known from U.S. Pat. No. 3,181,939, which describes fused alumina-zirconia grains containing 10% to 60% zirconia, the balance being alumina and impurities. U.S. Pat. No. 4,457,767 describes fused alumina-zirconia grains having a composition close to a eutectic composition, with an amount of zirconia close to 40% by weight, and which may comprise up to 2% yttrium oxide.

Compared to fused alumina-zirconia grains, fused alumina grains have a better efficacy (consumption of grains relative to the amount of material abraded) and a better energy efficiency for uses at low pressures or for finishing applications. This performance is generally explained by their specific microstructure which leads to fractures, and therefore to a maintenance of the number of cutting edges under lower stresses than for fused alumina-zirconia grains. Furthermore, fused alumina grains are less expensive than fused alumina-zirconia grains. In certain applications, the compromise between cost and performance is therefore considered to be better for alumina grains, and in particular for low material removal rates, in particular for finishing operations.

There is however a continuing need to improve the performance of alumina grains, and in particular the efficacy and the energy efficiency.

One aim of the invention is to at least partially address this need.

### SUMMARY OF THE INVENTION

According to the invention, this aim is achieved by means of a fused grain having the following chemical analysis, as percentages by weight based on the oxides:
ZrO₂+HfO₂: 2% to 13%;
Elements other than ZrO₂, HfO₂, Y₂O₃ and Al₂O₃: ≤2%.
Y₂O₃+Al₂O₃: balance to 100%;
   with 0.1300≥Y₂O₃/(ZrO₂+HfO₂)≥0.0065.

As will be seen in more detail in the remainder of the description, the inventors have discovered that with the above chemical composition, and in particular with the combination of the content of ZrO₂+HfO₂ and the Y₂O₃/(ZrO₂+HfO₂) weight ratio according to the invention, both the efficacy and the energy efficiency are better than those of known fused alumina grains. Without being limited by this theory, they explain this result by a microstructure which, surprisingly, is substantially identical to that of fused grains of pure alumina despite the presence of ZrO₂+HfO₂ and Y₂O₃.

A fused grain according to the invention can also have one or more of the following optional characteristics:
3%<ZrO₂+HfO₂<11%, preferably 4%<ZrO₂+HfO₂<10%, preferably 5%<ZrO₂+HfO₂<9%;
0.0100<Y₂O₃/(ZrO₂+HfO₂)<0.1000, preferably 0.0150<Y₂O₃/(ZrO₂+HfO₂)<0.0600, preferably 0.0170<Y₂O₃/(ZrO₂+HfO₂)<0.0300;
the total content of tetragonal and cubic zirconias, as weight percentages based on the total weight of the crystalline phases of zirconia, is greater than 30% and less than 95%, preferably greater than 40% and less than 80%, preferably greater than 50% and less than 70%;
the carbon content is greater than 50 ppm and less than 0.15%, preferably greater than 50 ppm and less than 0.06%, preferably greater than 50 ppm and less than 0.03%, as weight percentages based on the weight of the fused grain;
the fused grain comprises cubic zirconia;
the content of elements other than ZrO₂, HfO₂, Y₂O₃ and Al₂O₃ is less than 1.0%; preferably the elements other than ZrO₂, HfO₂, Y₂O₃ and Al₂O₃ are impurities;
Na₂O<0.3%, and/or SiO₂<0.3%, and/or TiO₂<0.2%, and/or Fe₂O₃<0.3%, and/or MgO<0.2% and/or CaO<0.2%.

The invention also relates to a mixture of grains comprising, as a weight percentage, more than 80% of fused grains according to the invention.

The invention also relates to a process for the manufacture of a mixture of fused grains according to the invention, said process comprising the following successive steps:
a) mixing raw materials so as to form a feedstock,
b) melting said feedstock until a molten material is obtained,
c) solidifying said molten material so that the molten material is completely solidified in less than 3 minutes,
d) optionally, and in particular if step c) does not result in grains being obtained, milling said solid mass so as to obtain a mixture of grains,
e) optionally, particle size selection.

According to the invention, the raw materials are chosen in step a) so that the solid mass obtained at the end of step c) has a composition in accordance with that of a grain according to the invention.

The invention lastly relates to an abrasive tool comprising grains bound by a binder and bonded, for example in the form of a grinding wheel, or deposited on a support, for example a belt or disk, this tool being noteworthy in that at least a portion, preferably more than 50%, preferably more than 70%, preferably more than 80%, preferably more than 90%, preferably more than 95%, preferably more than 99%, preferably all, of said grains are in accordance with the invention. The abrasive tool may in particular be a truing grinding wheel, a precision grinding wheel, a sharpening grinding wheel, a cut-off grinding wheel, a grinding wheel for machining from the body, a fettling or roughing grinding wheel, a regulating grinding wheel, a portable grinding wheel, a foundry grinding wheel, a drill grinding wheel, a mounted grinding wheel, a cylinder grinding wheel, a cone grinding wheel, a disk grinding wheel or a segmented grinding wheel or any other type of grinding wheel.

Generally, the invention relates to the use of grains according to the invention, in particular in an abrasive tool according to the invention, for abrading.

The grains according to the invention are particularly recommended for the machining of steel, in particular stainless steels.

### DEFINITIONS

The contents of oxides of a grain according to the invention relates to the overall contents for each of the corresponding chemical elements, expressed in the form of the most stable oxide, according to the standard convention of the industry; the suboxides and optionally nitrides, oxynitrides, carbides, oxycarbides, carbonitrides or even the metallic species of the abovementioned elements are thus included.

Within the context of this application, HfO₂ is considered to be chemically inseparable from ZrO₂. In the chemical composition of a product comprising zirconia, “ZrO₂” or “ZrO₂+HfO₂” therefore denotes the total content of these two oxides. According to the present invention, HfO₂ is not deliberately added to the feedstock. HfO₂ therefore denotes only traces of hafnium oxide, this oxide always being naturally present in sources of zirconia at contents generally of less than 2%.

The contents of tetragonal zirconia and cubic zirconia are measured by X-ray diffraction on a powder obtained by milling the fused grains, as described below, for the examples.

The term “impurities” means the unavoidable constituents necessarily introduced with the raw materials. In particular, the compounds that belong to the group of oxides, nitrides, oxynitrides, carbides, oxycarbides, carbonitrides and metallic species of sodium and other alkali metals, iron and vanadium are impurities. As examples, mention may be made of Fe₂O₃ or Na₂O. HfO₂ is not regarded as an impurity.

A “precursor” of an oxide is understood to mean a constituent capable of providing said oxide during the manufacture of a grain or of a mixture of grains according to the invention.

A “grain” is a particle for which all dimensions are less than 20 mm.

A “fused grain” or more broadly “fused product” is understood to mean a solid grain (or product) obtained by solidification by cooling of a molten material.

A “molten material” is a mass, rendered liquid by heating a feedstock, which may contain a few solid particles, but in an insufficient amount for them to be able to give structure to said mass. In order to retain its shape, a molten material has to be contained within a receptacle. The fused products based on oxides according to the invention are conventionally obtained by melting at more than 1900° C.

The “median size” of a powder refers to the size dividing the particles into first and second populations that are equal by weight, these first and second populations comprising only particles having a size of greater than or equal to, or respectively less than, the median size. The median size of a powder can be determined using a particle size distribution produced using a laser particle sizer.

In the present description, unless otherwise mentioned, all the compositions of a grain are given as weight percentages, based on the total weight of the oxides of the grain.

### DETAILED DESCRIPTION

The description which follows is provided for illustrative purposes and does not limit the invention.

### Fused Grain

The chemical composition of a fused grain according to the invention, and preferably of a mixture of grains according to the invention, preferably has one or more of the following optional characteristics:
the content of ZrO₂+HfO₂ is preferably greater than 3%, preferably greater than 4%, preferably greater than 5%, and preferably less than 12%, preferably less than 11%, preferably less than 10%, preferably less than 9%, as weight percentages based on the oxides. The inventors have discovered that a grain having a content of ZrO₂+HfO₂ of greater than 15% has a different microstructure from that of the grain according to the invention: the amount of eutectic phase, located between the alumina grains, is greater, and it helps to modify the fracturing regime of the grain during the use thereof. The preferred ZrO₂+HfO₂ ranges correspond to the best compromise between the cost and the performance of the grain;
the HfO₂ content is preferably less than 1%, preferably less than 0.5%, preferably less than 0.3%, preferably less than 0.2%, and/or greater than 0.02%, as weight percentages based on the oxides;
the Y₂O₃/(ZrO₂+HfO₂) weight ratio is preferably greater than 0.0070, preferably greater than 0.0080, preferably greater than 0.0090, preferably greater than 0.0100, preferably greater than 0.0110, preferably greater than 0.0120, preferably greater than 0.0150, preferably greater than 0.0170, preferably greater than 0.0180, preferably greater than 0.0190, and preferably less than 0.1200, preferably less than 0.1000, preferably less than 0.0800, or less than 0.0600, or less than 0.0500, or less than 0.0400, or less than 0.0300, or less than 0.0250;
the content of elements other than ZrO₂, HfO₂, Y₂O₃ and Al₂O₃ is preferably less than 1.8%, preferably less than 1.5%, preferably less than 1.2%, preferably less than 1%, preferably less than 0.8%, preferably less than 0.5%, as weight percentages based on the oxides;
the elements other than ZrO₂, HfO₂, Y₂O₃ and Al₂O₃ are preferably impurities;
the Na₂O content is preferably less than 0.3%, preferably less than 0.2%, preferably less than 0.15%, preferably less than 0.1%, preferably less than 0.08%, preferably less than 0.05%, as weight percentages based on the oxides;
the SiO₂ content is preferably less than 0.3%, preferably less than 0.2%, preferably less than 0.15%, preferably less than 0.1%, preferably less than 0.08%, preferably less than 0.05%, as weight percentages based on the oxides;
the TiO₂ content is preferably less than 0.2%, preferably less than 0.15%, preferably less than 0.13%, preferably less than or equal to 0.12%, as weight percentages based on the oxides;
the Fe₂O₃ content is preferably less than 0.3%, preferably less than 0.2%, preferably less than 0.15%, preferably less than 0.1%, preferably less than 0.08%, preferably less than 0.05%, as weight percentages based on the oxides;
the MgO content is preferably less than 0.2%, preferably less than 0.15%, preferably less than 0.1%, preferably less than 0.08%, and/or greater than 0.05%, as weight percentages based on the oxides;
the CaO content is preferably less than 0.2%, preferably less than 0.15%, preferably less than 0.1%, preferably less than 0.08%, and/or greater than 0.05%, as weight percentages based on the oxides;
the content of oxides is greater than 98%, preferably greater than 99%, preferably greater than 99.4%, preferably greater than 99.5%, preferably greater than 99.6%, preferably greater than 99.7%, as weight percentages based on the weight of the fused grain;
the carbon content is greater than 30 ppm, preferably greater than 50 ppm, preferably greater than 80 ppm and/or preferably less than 0.15%, preferably less than 0.1%, preferably less than 0.08%, preferably less than 0.06%, preferably less than 0.05%, preferably less than 0.04%, preferably less than 0.03%, as weight percentages based on the weight of the fused grain.

The crystalline phases of a fused grain according to the invention preferably have one or more of the following optional characteristics:
the total content of tetragonal and cubic zirconias, as weight percentages based on the total weight of the crystalline phases of zirconia is preferably greater than 30%, preferably greater than 40%, preferably greater than 50%, preferably greater than 55%, preferably greater than 60%, and/or preferably less than 95%, preferably less than 90%, preferably less than 85%, preferably less than 80%, preferably less than 75%, preferably less than 70%;
the zirconia is at least partly in cubic form.

Without being able to explain it theoretically, the inventors have found that these crystallographic characteristics are advantageous.

A fused grain according to the invention has a microstructure substantially composed of alumina crystals, said crystals being separated by boundaries in which ZrO₂ and Y₂O₃ are located. Preferably, the elements other than Al₂O₃, ZrO₂ and Y₂O₃ are substantially entirely located in said boundaries.

Preferably, the mean size of the alumina crystals is less than 50 μm, preferably less than 40 μm, preferably less than 30 μm, preferably less than 25 μm, or less than 20 μm, and/or preferably greater than 3 μm, preferably greater than 4 μm.

To reduce the mean size of the alumina crystals of the fused grain according to the invention, it is possible, in step c) of the process according to the invention, to reduce the time required to completely solidify the molten material.

### Mixture of Grains

A mixture of grains according to the invention comprises, as weight percentages, preferably more than 85%, preferably more than 90%, preferably more than 95%, preferably more than 99%, preferably substantially 100%, of fused grains according to the invention.

Preferably, a mixture of grains according to the invention complies with a particle size distribution in accordance with those of the mixtures or grits provided by the FEPA Standard 43-GB-1984, R1993 and the FEPA Standard 42-GB-1984, R1993.

Preferably, a grain mixture according to the invention has a weight oversize on a 16 mm screen, preferably on a 9.51 mm screen, measured using a Ro-Tap® sieve shaker, of less than 1%.

### Process for Manufacturing a Fused Grain According to the Invention

Fused grains according to the invention may be manufactured according to the abovementioned steps a) to e), which are conventional for the manufacture of fused alumina grains. The parameters may, for example, take the values of the process used for the examples below.

In step a), raw materials are conventionally metered out, so as to obtain the desired composition, and then mixed to form the feedstock.

The metals Zr, Hf, Al and Y in the feedstock are found substantially in full in the fused grains.

Choosing the raw materials of the feedstock so that the solid mass obtained at the end of step c) has a composition in accordance with that of a grain according to the invention thus does not present any difficulty to those skilled in the art.

The metals Zr, Hf, Al and Y are preferably introduced into the feedstock in the form of oxides ZrO₂, HfO₂, Al₂O₃ and Y₂O₃. They may also be conventionally introduced in the form of precursors of these oxides.

In one embodiment, the feedstock comprises an amount of carbon, preferably in the form of coke, of between 0.2% and 4%, based on the weight of the feedstock.

In one embodiment, in particular when the raw materials present in the feedstock have a low content of impurities, the feedstock consists of oxides ZrO₂, HfO₂, Al₂O₃ and Y₂O₃ and/or precursors of these oxides.

It is considered that a content of “other elements” of less than 2% in the grains does not suppress the advantageous technical effect of the invention.

The “other elements” are preferably impurities.

In step b), use is preferably made of an electric arc furnace, preferably of Héroult type with graphite electrodes, but any furnace known may be envisaged, such as an induction furnace or a plasma furnace, provided that they make it possible to melt the feedstock.

The raw materials are preferably melted in a reducing medium (obtained by the presence of carbon in the feedstock and/or by the fact that the electrodes are immersed in the bath of molten material), preferably at atmospheric pressure.

Preferably, use is made of an electric arc furnace, comprising a vessel with a capacity of 70 liters, with a melting energy before pouring of more than 1.9 kWh per kg of raw materials for a power of more than 209 KW, or an electric arc furnace with a different capacity used under equivalent conditions. A person skilled in the art knows how to determine such equivalent conditions.

In step c), the cooling has to be rapid, that is to say so that the molten material is completely solidified in less than 3 minutes. For example, it may result from a pouring into molds, as described in U.S. Pat. No. 3,993,119, or from a quenching.

Preferably, the molten material is completely solidified in less than 2 minutes, preferably in less than one minute, preferably in less than 40 seconds, preferably in less than 30 seconds.

If step c) does not make it possible to obtain a mixture of grains directly, or if these grains do not have a suitable particle size for the targeted application, milling (step d)) may be carried out, according to conventional techniques.

In step e), if the preceding stages do not make it possible to obtain a mixture of grains having a suitable particle size for the targeted application, a particle size selection, for example by screening or cycloning, may be carried out.

### Abrasive Tools

The processes for manufacturing the abrasive tools according to the invention are well known.

The abrasive tools may in particular be formed by agglomerating grains according to the invention by means of a binder, in particular in the form of a grinding wheel, for example by pressing, or be formed by attaching grains according to the invention to a support, for example a belt or a disk, by means of a binder.

The binder can be inorganic, in particular a glass (for example, a binder consisting of oxides, substantially consisting of silicate(s) can be used) or organic.

An organic binder is highly suitable. The binder may in particular be a thermosetting resin. It is preferably chosen from the group consisting of phenolic, epoxy, acrylate, polyester, polyamide, polybenzimidazole, polyurethane, phenoxy, phenol-furfural, aniline-formaldehyde, urea-formaldehyde, cresol-aldehyde, resorcinol-aldehyde, urea-aldehyde or melamine-formaldehyde resins, and mixtures thereof.

The binder may also incorporate organic or inorganic fillers, such as hydrated inorganic fillers (for example aluminum trihydrate or boehmite) or nonhydrated inorganic fillers (for example molybdenum oxide), cryolite, a halogen, fluorspar, iron sulfide, zinc sulfide, magnesia, silicon carbide, silicon chloride, potassium chloride, manganese dichloride, potassium or zinc fluoroborate, potassium fluoroaluminate, calcium oxide, potassium sulfate, a copolymer of vinylidene chloride and vinyl chloride, polyvinylidene chloride, polyvinyl chloride, fibers, sulfides, chlorides, sulfates, fluorides, and mixtures thereof. The binder may also contain reinforcing fibers, such as glass fibers.

Preferably, the binder represents between 2% and 60%, preferably between 20% and 40%, by volume of the mixture.

### EXAMPLES

The following nonlimiting examples are given for the purpose of illustrating the invention.

### Measurement Protocols

The following measurement protocols were used to determine certain properties of mixtures of fused grains. They allow an excellent simulation of the real behavior of the grains when they are used for abrasion.

In order to evaluate the abrasive performance of the mixtures of grains, grinding wheels with a diameter of 12.7 cm, containing 1 gram of grains of each example, were produced.

Plates made of 304 stainless steel, with dimensions of 20.5 cm×7.6 cm×6.0 cm, were subsequently machined at the surface with these grinding wheels, with a to-and-fro movement at a constant speed while maintaining a constant cutting depth of 40 μm and a rotational speed of the grinding wheel of 3600 rpm. The total energy developed by the grinding wheel during machining, Eₜₒₜ, was recorded.

After the grinding wheel has been completely worn away, the weight of machined steel (that is to say, the weight of steel removed by the grinding operation), “Mₐ”, and the weight of grinding wheel consumed, “Mₘ”, and the volume of steel removed by the grinding operation “Vₐ” were measured.

To evaluate the efficacy, the ratio S of the weight of steel machined divided by the weight of grains consumed during said machining is calculated conventionally (S=Mₐ/Mₘ).

To evaluate the energy efficiency, the specific energy of machining, Es, equal to the energy required to remove a unit volume of steel is calculated conventionally (Es=Eₜₒₜ/Vₐ).

The total amount of tetragonal and cubic zirconias, referred to as “stabilized zirconia”, as weight percentages based on the total weight of the crystalline phases of zirconia, is determined by X-ray diffraction on samples dry-milled in an RS 100 mill sold by Retsch, equipped with a tungsten carbide bowl having an internal diameter equal to 80 mm and an internal height equal to 40 mm and a tungsten carbide pebble, having a diameter equal to 45 mm and a height equal to 35 mm.

20 g of grains according to the invention having a size of between 425 μm and 500 μm are first selected in step e), by screening. These grains are then milled for 30 seconds in the mill, the speed selected being equal to 14 000 rpm. After milling, the recovered powder is screened through a 40 μm screen and only the undersize is used for the X-ray diffraction measurement

The diffraction diagram is acquired using a D8 Endeavor device from Bruker, over a 2θ angular range of between 5° and 100°, with a step of 0.01°, and a count time of 0.34 s/step. The front lens has a 0.3° primary slit and a 2.5° Soller slit. The sample is rotated about itself at a speed equal to 15 rpm, with use of the automatic knife. The rear lens has a 2.5° Soller slit, a 0.0125 mm nickel filter and a 1D detector with an aperture equal to 4°.

The diffraction patterns are subsequently analyzed qualitatively using the EVA software and the ICDD2016 database.

A single (tetragonal or cubic) stabilized phase is assumed.

Once the phases present have been detected, the diffraction diagrams are analyzed with the HighScore Plus software from the company Malvern Panalytical, using the “pseudo Voigt split width” function and the area of the (−111) and (111) planes of the monoclinic zirconia phase and the area of the peak of the (111) plane of the stabilized zirconia phase are determined.

Namely:
A_{M(-111)}: the area of the peak of the (−111) plane of the monoclinic zirconia phase, located at around 2θ=28.2°,
A_{M(111)}: the area of the peak of the (111) plane of the monoclinic zirconia phase, located at around 2θ=31.3°,
A_{S(111)}: the area of the peak of the (111) plane of the stabilized zirconia phase (in tetragonal and/or cubic form), located at around 2θ=30.2°,
d_{M}: the density of monoclinic zirconia, taken as equal to 5.8 g/cm³,
d_{S}: the density of stabilized zirconia, taken as equal to 6.1 g/cm³.

The amount by weight of tetragonal and cubic zirconia, as percentages based on the total weight of the crystalline phases of zirconia, is equal to:

$$( 1 - \frac{1.311 * {A}_{M} * {d}_{M}}{1.311 * {A}_{M} * {d}_{M} + {A}_{S} * {d}_{S}} ) * 100$$

With the exception of the carbon content, the chemical analysis of the fused grains is measured by the inductively coupled plasma (ICP) technique, for Y₂O₃ and for the elements with a content that does not exceed 0.5%. In order to determine the content of the other elements, a bead of the product to be analyzed is manufactured by melting the product, then the chemical analysis is carried out by x-ray fluorescence.

The carbon content of the fused grains is measured using a CS744 model carbon-sulfur analyzer, sold by LECO.

The median size of a powder is measured conventionally using an LA950V2 model laser particle sizer sold by Horiba.

The mean size of the alumina crystals of the fused grains of the examples is measured by the “Mean Linear Intercept” method. A method of this type is described in the standard ASTM E1382. According to this standard, analysis lines are plotted on images of the fused grains, then, along each analysis line, the lengths l, referred to as “intercepts”, between two boundaries separating two consecutive crystals intersecting said analysis line, are measured.

The mean length “l′” of the intercepts “l ” is subsequently determined.

For the mixtures of grains of the examples, the intercepts were measured on images, obtained by scanning electron microscopy, of fused grains having a size of between 500 μm and 600 μm, said sections having previously been polished until a mirror quality was obtained. The magnification used for taking the images is chosen so as to see, on one image, between 130 and 160 alumina crystals not cut by the edges of the image. 5 images per mixture of gains were produced, each on a different grain. At least 100 intercepts are measured per image.

The mean size “d” of the alumina crystals of a mixture of fused grains is equal to the mean l′ of the intercepts l measured on all of the 5 images.

### Manufacturing Protocol

The products of the examples were prepared from the following raw materials:
alumina powder with a purity greater than 99.6% by weight, comprising the impurities Na₂O, CaO, Fe₂O₃, MgO, TiO₂, SiO₂, and having a median size equal to 80 μm;
zirconia powder with a purity greater than 99.4% by weight, comprising the impurities Al₂O₃, CaO, Y₂O₃, MgO, TiO₂, SiO₂, and having a median size equal to 1.5 μm;
yttrium oxide powder with a purity greater than 99.999% by weight, having a median size of between 3 and 6 μm.

The grains were prepared according to the following conventional manufacturing process, in accordance with the invention:
a) mixing raw materials so as to form a feedstock,
b) melting said feedstock in a single-phase electric arc furnace of Héroult type comprising graphite electrodes, with a furnace vessel having a diameter of 0.8 m, a voltage of 95 V, a current of 2200 A and a specific electrical energy supplied of 1.9 kWh/kg charged,
c) sudden cooling of the molten material by means of a device for casting between thin metal plates, such as that presented in the patent U.S. Pat. No. 3,993,119, so as to obtain a completely solid sheet, constituting a solid mass,
d) milling said solid mass cooled in step c), so as to obtain a mixture of grains,
e) selecting, by screening using a Ro-Tap® sieve shaker, the grains having a size of between 500 and 600 μm.

Table 1 below provides the chemical composition and the proportion of cubic zirconia of the various mixtures of fused grains, and also the results obtained with these mixtures.

The percentage of improvement in the S ratio is calculated by the following formula:

100·(ratio S of the product of the example considered−ratio S of the product of reference example 1)/ratio S of the product of reference example 1.

A high positive value of the percentage improvement in the ratio S is desired. The inventors consider an improvement of more than 5% in the ratio S to be significant.

Preferably, the ratio S is improved by more than 10%, preferably by more than 15%, preferably by more than 20%, preferably by more than 25%, preferably by more than 30%, preferably by more by 35%.

The percentage reduction in specific energy, Es, is calculated by the following formula:

100·(Es with the product of reference example 1−Es with the product of the example considered)/Es of the product of reference example 1.

A high positive value of the percentage reduction in the specific energy Es during the test is desired. The inventors consider a reduction of more than 5% in the specific energy Es to be significant. Preferably, the specific energy is reduced by more than 10%, preferably by more than 15%.

The amount of tetragonal and cubic zirconia is provided as weight percentages based on the total weight of the crystalline phases of zirconia.

Reference example 1, outside the invention, is a mixture of fused grains sold by Saint-Gobain Ceramic Materials under the name MA88K-weak.

TABLE 1

| | | | | | | | |
|---|---|---|---|---|---|---|---|
| Ex. 1 | Ex. 2 | Ex. 3 | Ex. 4 | Ex. 5 | Ex. 6 | Ex. 7 | Ex. 8 |

Chemical analysis, as weight percentages based on the oxides

| Al₂O₃ | Balance to 100% | | | | | | | |
|---|---|---|---|---|---|---|---|---|
| ZrO₂ + HfO₂ | — | 6.2 | 6.4 | 8.14 | 5.6 | 4.04 | 8.31 | 8.45 |
| Y₂O₃ | — | 0.04 | 0.08 | 0.17 | 0.13 | 0.1 | 0.36 | 1.2 |
| Elements other than Al₂O₃, | 0.5 | <0.5 | <0.5 | <0.5 | <0.5 | <0.5 | <0.5 | <0.5 |
| ZrO₂, HfO₂ and Y₂O₃ | | | | | | | | |
| of which Na₂O | 0.07 | <0.05 | <0.05 | <0.05 | <0.05 | <0.05 | <0.05 | <0.05 |
| of which SiO₂ | 0.01 | <0.05 | <0.05 | <0.05 | <0.05 | <0.05 | <0.05 | <0.05 |
| of which TiO₂ | 0.4 | 0.12 | 0.11 | 0.12 | 0.12 | 0.12 | 0.12 | 0.12 |
| of which Fe₂O₃ | 0.02 | <0.05 | <0.05 | <0.05 | <0.05 | <0.05 | <0.05 | <0.05 |
| of which MgO | — | <0.05 | <0.05 | <0.05 | <0.05 | <0.05 | <0.05 | <0.05 |
| of which CaO | — | <0.05 | <0.05 | <0.05 | <0.05 | <0.05 | <0.05 | <0.05 |
| Y₂O₃/(ZrO₂ + HfO₂) | — | 0.0065 | 0.0125 | 0.0209 | 0.0232 | 0.0248 | 0.0433 | 0.1420 |

Other characteristics

| | | | | | | | | |
|---|---|---|---|---|---|---|---|---|
| Carbon (ppm) based on the | 30 | n.d. | n.d. | 110 | n.d. | n.d. | n.d. | n.d. |
| weight of grains | | | | | | | | |
| Amount of tetragonal and | — | 36 | 46 | 67 | 65 | 60 | 90 | 100 |
| cubic zirconia | | | | | | | | |
| % improvement in S | — | 20 | 25 | 42 | 41 | 31 | 24 | 17 |
| % reduction in Es | — | 5 | 8 | 16 | 18 | 14 | 9 | −7 |

n.d.: not determined

The mean size of the alumina crystals is between 5 μm and 25 μm for the grains from examples 2 to 8.

The inventors found that a ZrO₂ content of less than 2% does not make it possible to improve the abrasive performance.

The inventors also found that a ZrO₂ content of greater than 13% was responsible for a modification of the microstructure of the fused grain, said microstructure passing from a microstructure mainly composed of corundum grains and having zirconia at the grain boundaries to a microstructure comprising a sizeable amount of alumina-zirconia eutectic phase.

A comparison of comparative example 1 and example 2 shows the importance of the Y₂O₃/(ZrO₂+HfO₂) weight ratio: for such a ratio equal to 0.0065, the ratio S is improved by 20% and the specific energy is reduced by 5%.

A comparison of comparative example 1 and example 8 outside the invention shows that a Y₂O₃/(ZrO₂+HfO₂) weight ratio equal to 0.14 improves the ratio by 17%, but results in an increase in specific energy of 7%.

A comparison of comparative example 1 and examples 3, 4, 5, 6 and 7 shows the importance of the Y₂O₃/(ZrO₂+HfO₂) weight ratio, equal to 0.0125, 0.0209, 0.0232, 0.0248 and 0.0433, respectively: the ratio S is improved by 25%, 42%, 41%, 31% and 24% respectively, and the specific energy is reduced by 8%, 16%, 18%, 14% and 9%, respectively.

Examples 4 and 5 are the examples that are preferred among them all.

As is now clearly apparent, the invention provides a mixture of fused grains consisting mainly of alumina, and therefore of lower cost than fused alumina-zirconia grains, and having better efficacy and energy efficiency than those of known alumina grains.

Of course, the present invention is not limited to the embodiments described, which are provided by way of illustrative and nonlimiting examples.

In particular, the fused grains according to the invention are not limited to particular shapes or dimensions.

1. A fused grain having the following chemical analysis, as weight percentages based on the oxides:
ZrO₂+HfO₂: ≥2% and <10%;
Elements other than ZrO₂, HfO₂, Y₂O₃ and Al₂O_{3:≤2}%;
Y₂O₃+Al₂O₃: balance to 100%;
with 0.0065≤Y₂O₃/(ZrO₂+HfO₂)≤0.1300.

2. The fused grain as claimed in claim 1, wherein
3%<ZrO₂+HfO₂, and/or
0.0100<Y₂O₃/(ZrO₂+HfO₂)<0.1000, and/or
wherein the total content of tetragonal and cubic zirconias, as weight percentages based on the total weight of the crystalline phases of zirconia, is greater than 30% and less than 95%, and/or
wherein the carbon content is greater than 30 ppm and less than 0.15%, as weight percentages based on the weight of the fused grain.

3. The fused grain as claimed in claim 2, wherein
4%<ZrO₂+HfO₂, and/or
0.0150<Y₂O₃/(ZrO₂+HfO₂)<0.080, and/or
wherein the total content of tetragonal and cubic zirconias, as weight percentages based on the total weight of the crystalline phases of zirconia, is greater than 40% and less than 80%, and/or
wherein the carbon content is greater than 30 ppm and less than 0.1%, as weight percentages based on the weight of the fused grain.

4. The fused grain as claimed in claim 3, wherein
5%<ZrO₂+HfO_{2<9}%, and/or
0.0170<Y₂O₃/(ZrO₂+HfO₂), and/or
wherein the total content of tetragonal and cubic zirconias, as weight percentages based on the total weight of the crystalline phases of zirconia, is greater than 50% and less than 70%, and/or
wherein the carbon content is greater than 30 ppm and less than 0.08%, as weight percentages based on the weight of the fused grain.

5. The fused grain as claimed in claim 1, comprising cubic zirconia.

6. The fused grain as claimed in claim 1, wherein the content of elements other than ZrO₂, HfO₂, Y₂O₃ and Al₂O₃ is less than 1.0%.

7. The fused grain as claimed in claim 6, wherein the elements other than ZrO₂, HfO₂, Y₂O₃ and Al₂O₃ are impurities.

8. The fused grain as claimed in claim 1, wherein Na₂O<0.3%, SiO₂<0.3%, TiO₂<0.2%, Fe₂O₃<0.3%, MgO<0.2% and CaO<0.2%.

9. The fused grain as claimed in claim 1, comprising a carbon content of greater than 80 ppm, as weight percentages based on the weight of the fused grain.

10. The fused grain as claimed in claim 1, wherein the content of TiO₂ is less than 0.2%, as weight percentages based on the oxides.

11. A mixture of grains comprising, as weight percentages, more than 80% of grains as claimed in claim 1.

12. A process for manufacturing a mixture of fused grains as claimed in preceding claim 11, said process comprising the following successive steps:
a) mixing raw materials so as to form a feedstock,
b) melting said feedstock until a molten material is obtained,
c) solidifying said molten material so that the molten material is completely solidified in less than 3 minutes,
d) optionally, and in particular if step c) does not result in grains being obtained, milling said solid mass so as to obtain a mixture of grains,
e) optionally, particle size selection.

13. An abrasive tool comprising grains bound by a binder, bonded or deposited on a support, at least a portion of said grains being in accordance with claim 1.

14. An abrasive tool comprising grains bound by a binder, bonded or deposited on a support comprising more than 80% of grains as claimed in any one of claim 1.

15. The abrasive tool as claimed in claim 13, in the form of a grinding wheel, a belt or a disk.
